(19) United States
(12) Patent Application Publication
(10) Pub. No.: US 2002/0016162 A1
(43) Pub. Date: Feb. 7, 2002

(54) Method for provision of contents

(75) Inventors: Kiyohito Yoshihara, Tokyo (JP); Hiroki Horiuchi, Saitama (JP); Toshikane Oda, Saitama (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: KDDI CORPORATION, Tokyo (JP)

(21) Appl. No.: 09/907,766

(22) Filed: Jul. 19, 2001

(30) Foreign Application Priority Data
Aug. 3, 2000 (JP) 2000-235338

(51) Int. Cl. H04M 11/10

(52) U.S. Cl. 455/412; 455/414; 455/422

(57) ABSTRACT

The present invention provides a contents provision method where contents required by a user may be provided with high quality at a place and a time which are reserved by the user.

The present invention comprises a step for display of a reservation screen on which the content ID, and geographical and time conditions for download of the contents are reserved; a step for selection of a temporary storage means meeting the reserved geographical conditions among a plurality of temporary storage means which are geographically arranged in a downloaded manner; a step for storage of contents, which are corresponding to the ID input on the reservation screen, into the selected temporary storage means after acquisition of the contents on the network; and a step for download of the contents stored in the temporary storage means to the mobile terminal at a timing satisfying the time conditions input on the reservation screen.

### BACKGROUND OF THE INVENTION

1. Field of the Invention

The present invention relates to a contents provision method for downloading contents responding to user requirements from a predetermined temporary storage means, for example, a cache server to a mobile terminal where the contents have been downloaded from a contents server on a network to the cache server.

2. Description of the Related Art

As a download method of contents required by a user to a mobile terminal, a preliminary storage method, where contents which are obtained from a contents server on a network responding to user requirements are temporarily stored beforehand in a cache server arranged at a position near from a mobile terminal, and, thereafter, the contents are downloaded from the cache server to the mobile terminal at a desired timing, has been disclosed, for example, in a Japanese published unexamined patent application No. HEI-11(1999)-272711.

The technology is based on an assumption that the mobile terminal is a fixed terminal. Therefore, it has been impossible to apply the technology to a mobile network environment, like the ITS (Intelligent Transport System) for which research and development has been being carried out all over the world, where the mobile terminal may freely move.

There is some distance between the cache server on a network and the mobile terminal in the mobile network environment, as a place for transmitting a demand for reservation of contents is different from one for receiving the reserved contents for the user.

Moreover, degradation in communication quality such as reduction in the bandwidth and increase in the error rate is easily caused, and there is also longer communication time in the mobile network environment in the case of contents download from the cache server to the mobile terminal, as there is included a wireless communication district at least in a part of a communication district.

### SUMMARY OF THE INVENTION

The object of the present invention is to provide a contents provision method where contents required by a user may be provided with high quality at a place and a time which are reserved by the user.

The present invention comprises a step for display of a reservation screen on which the content ID, and geographical and time conditions for download of the contents are reserved; a step for selection of a temporary storage means meeting the reserved geographical conditions among a plurality of temporary storage means which are geographically arranged in a downloaded manner; a step for storage of contents, which are corresponding to the ID input on the reservation screen, into the selected temporary storage means after acquisition of the contents on the network; and a step for download of the contents stored in the temporary storage means to the mobile terminal at a timing satisfying the time conditions input on the reservation screen.

According to the above aspect of the invention, when the user reserves contents which the user wants to acquire, and the corresponding date and place, the reserved contents are temporarily stored beforehand into a cache server at a position suitable for provision of the contents at the reserved time and the reserved place. Therefore, the user may receive the desired contents downloaded with high quality even from a mobile terminal in a short time without any restrictions on times and places.

### BRIEF DESCRIPTION OF THE DRAWINGS

FIG. 1 is a view showing a configuration example of a network to which a contents provision method according to the present invention is applied.

FIG. 2 is a view showing one example of a “DOWNLOAD RESERVATION SERVICE” screen.

FIG. 3 is a view showing a “CONTENTS RESERVATION” screen.

FIG. 4 is a view showing a “CONFIRMATION OF CONTENTS RESERVATION” screen.

FIG. 5 is a view showing a “CONTENTS RESERVATION ACCEPTANCE” screen.

FIGS. 6, 7, 8 are views showing “MAP DISPLAY” screen.

FIG. 9 is a view showing a “FIELD SELECTION” screen of the contents.

FIG. 10 is a view showing a “CONTENTS SELECTION” screen.

FIG. 11 is a view showing a “CONTENTS RESERVATION INQUIRY” screen.

FIG. 12 is a view showing a “CONTENTS RESERVATION INQUIRY (DETAILS)” screen.

FIG. 13 is a view showing a “CONTENTS RESERVATION CANCELLATION” screen.

FIG. 14 is a view showing a “CONFIRMATION OF CONTENTS RESERVATION CANCELLATION” screen.

FIG. 15 is a view showing a “COMPLETION OF DOWNLOAD” screen.

FIG. 16 is a view showing a “FAILURE IN CONTENTS DOWNLOAD” screen.

FIG. 17 is a view showing screen transition among FIG.2 to FIG. 16.

FIG.18 shows the reservation data registered in schedule server.

FIG.19 is a view of a typical expression of a contents list.

FIGS. 20 to 24 are sequence diagrams showing a flow according to the present invention.

### DETAILED DESCRIPTION OF THE PREFERRED EMBODIMENT

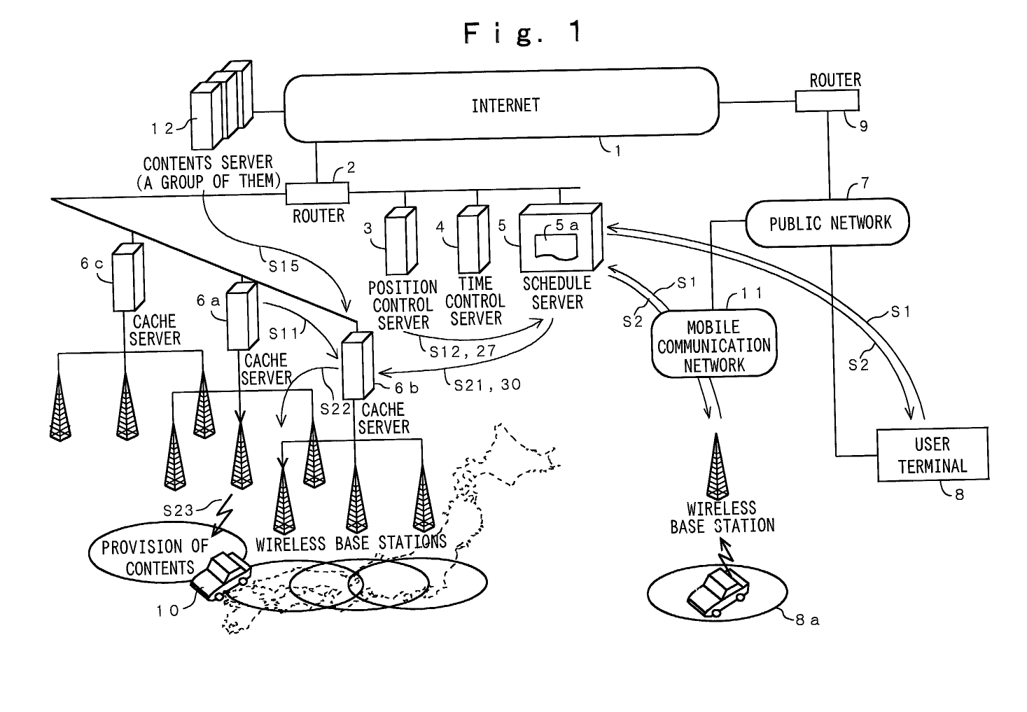

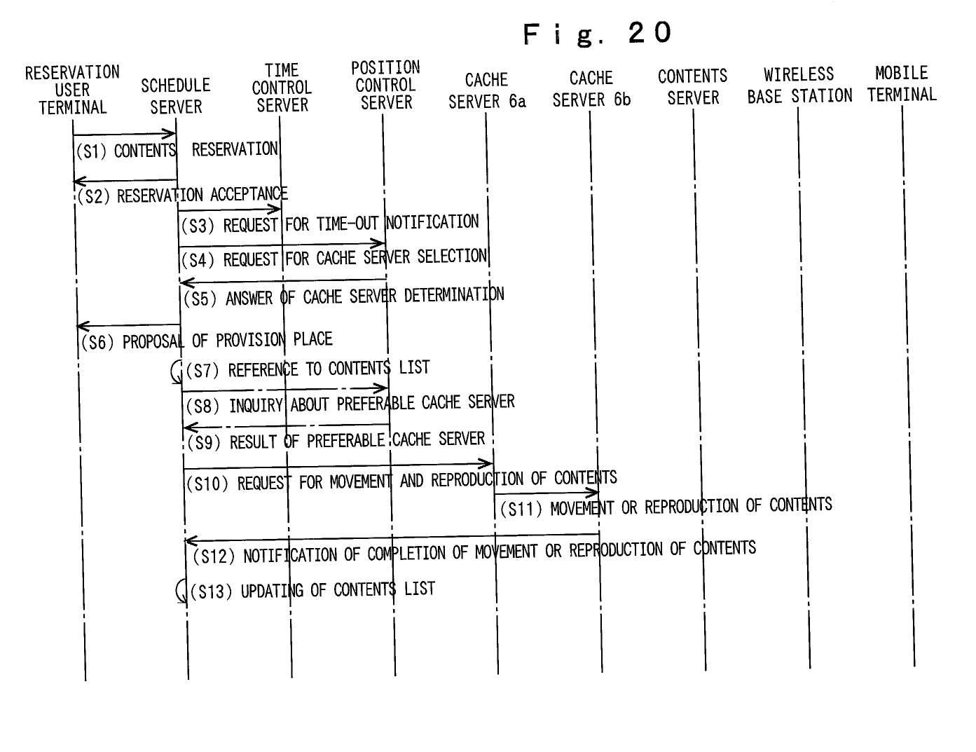

FIG. 1 is a view showing a configuration example of a network to which a contents provision method according to the present invention is applied. Step numbers S1, S2, and so on given to each arrow are responding to step numbers in FIGS. 20 to 24 which will be described later.

A position control server 3, a time control server 4 and a schedule server 5, and, furthermore, a plurality of cache servers 6a, 6b, 6c which are arranged so as to be dispersed geographically are connected to the Internet 1 through a router 2. A plurality of wireless base stations which are arranged so as to be dispersed geographically are connected to each cache server 6a, 6b, 6c.

A user terminal 8 for a user to reserve a download of contents is, for example, a personal computer or a telephone, and is connected to the Internet 1 through a public network 7 and a router 9. The demand for reservation of contents by the user may be realized not only with the user terminal 8, but also with an on-board terminal 8a. The on-board terminal 8a is connected to the public network 7 through the wireless base stations and a mobile communication network 11.

The contents reserved by the user are temporarily stored in a plurality of or any one of cache servers 6 (6a, 6b, 6c) from the contents servers (a group of them), and subsequently are provided to a user terminal as a provision end (hereinafter called as a mobile terminal) 10 at a predetermined reservation timing through the wireless base stations.

The reserved contents are provided to the mobile terminal 10 directly from the pertinent cache server or another pertinent cache server after transfer from the pertinent cache server to the another pertinent cache server, if the reserved contents have already been temporarily stored in any one of the cache servers 6. The mobile terminal 10 may be used as both the user terminal 8 and the on-board terminal 8a.

The contents reservation method according to the present embodiment will be described, referring to screens displayed on a display of the reservation user terminal 8. FIG. 17 is a view showing screen transition among each screen which will be hereinafter described.

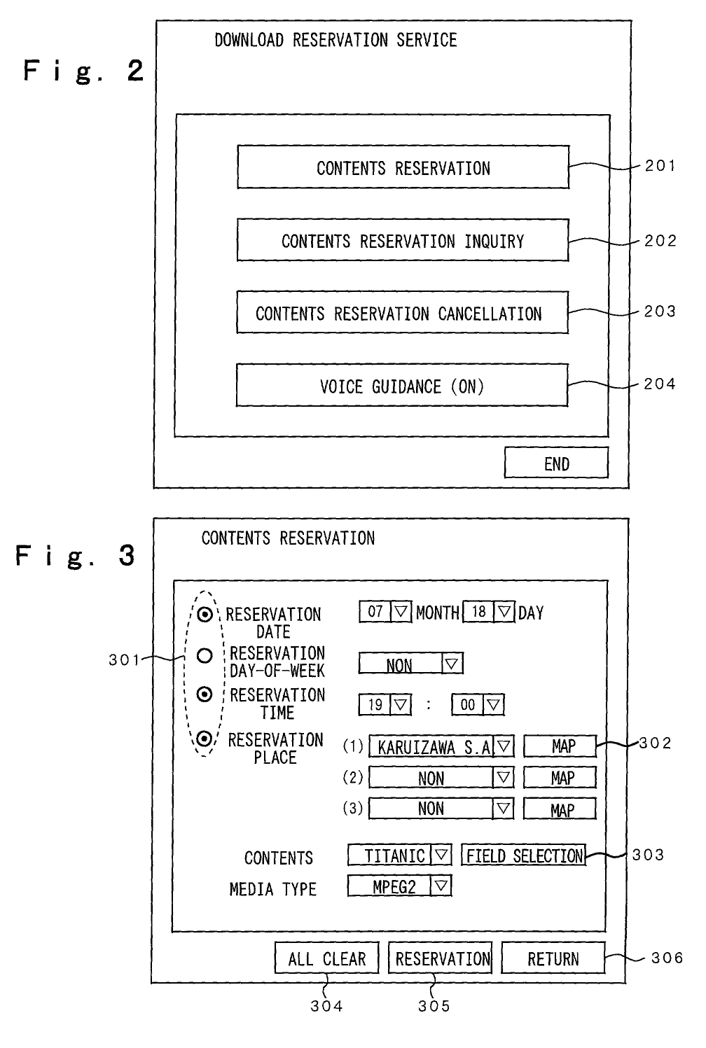

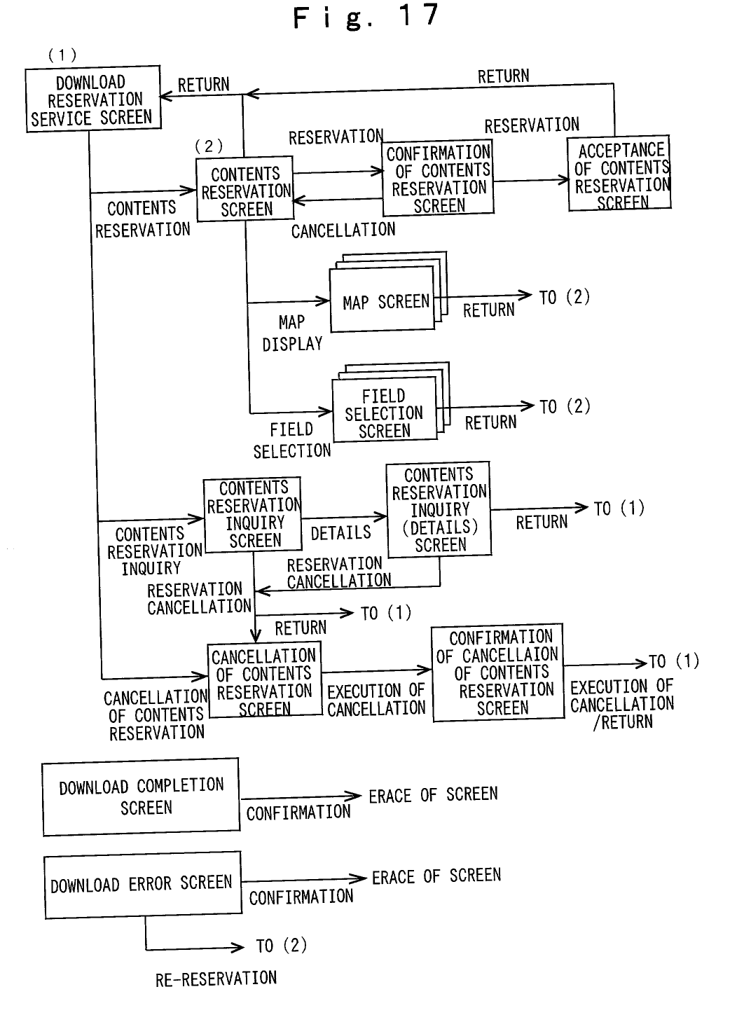

FIG. 2 is a view showing one example of a “DOWNLOAD RESERVATION SERVICE” screen (a menu screen) as an initial screen. In the present embodiment, a “CONTENTS RESERVATION” button 201 for opening a “CONTENTS RESERVATION” screen (FIG. 3): a “CONTENTS RESERVATION INQUIRY” button 202 for opening a “CONTENTS RESERVATION INQUIRY” screen (FIG. 11): a “CONTENTS RESERVATION CANCELLATION” button 203 for opening a “CONTENTS RESERVATION CANCELLATION” screen (FIG. 13): and a “VOICE GUIDANCE” button 204 for determination whether voice guidance is required or not are provided.

FIG. 3 is a view showing one example of a “CONTENTS RESERVATION” screen which is displayed when the “CONTENTS RESERVATION” button 201 (FIG. 2) is clicked.

With an item “RESERVATION DATE”, a date for download of contents desired by the user is determined with a pull-down menu. With an item “RESERVATION DAY-OF-WEEK”, a day-of-week for download of contents desired by the user is determined with a pull-down menu. With the item “RESERVATION DAY-OF-WEEK”, determination such as “EVERY TUESDAY”, “FROM MONDAY TO FRIDAY”, and “FROM MONDAY TO FRIDAY EVERY WEEK” may be realized. With an item “RESERVATION TIME”, a time for contents acquisition desired by the user is determined with a pull-down menu.

With an item “RESERVATION PLACE”, a place for download of contents desired by the user is determined with a pull-down menu. Determination of the “RESERVATION PLACE” may be realized not only with the pull-down menu, but also by clicking a “MAP” button 302 for display of a map screen to determine a desired place on the pertinent map screen, as specifically described below. Or, the determination may be also realized by input of a proper noun such as an address, a station name, and a spot name. Descriptions for each item are effective only when radio buttons 301 responding to each item has been selected.

In the present embodiment, the radio buttons of the “RESERVATION DATE” and the “RESERVATION DAY-OF-WEEK” may not be simultaneously selected.

With an item “CONTENTS”, contents desired by the user may be determined with a pull-down menu. In the present embodiment, hierarchical determination may be also realized by clicking a “FIELD SELECTION” button 303 as described later. With an item “MEDIA TYPE”, determination of an access format for contents may be determined by the user with a pull-down menu. As a default option, for example, a type with the most excellent reproduction quality is reserved.

The example of FIG. 3 shows a reservation of a movie “TITANIC” from 19:00 on July 18 in a format of MPEG2 at Karuizawa Service Area (S. A.).

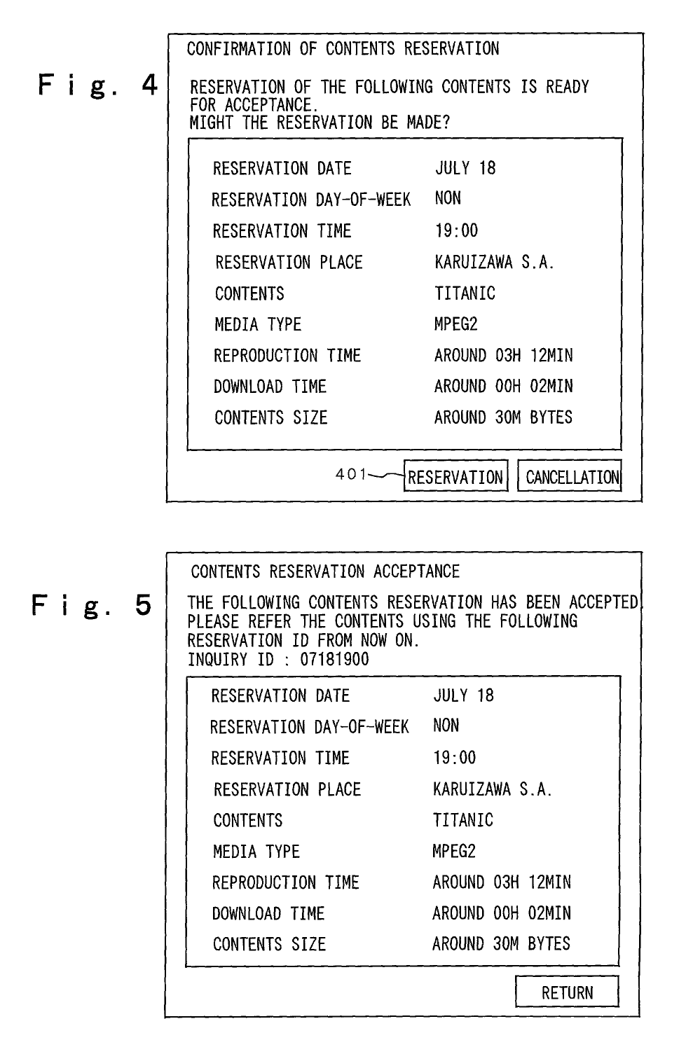

All items displayed on the screen are returned to the initial state by clicking a “ALL CLEAR” button 304. When a “RESERVATION” button 305 is clicked, it is inspected whether selected contents displayed on a screen is effective or not, and, if so, a confirmation of contents reservation screen (FIG. 4) is displayed. If not, another screen notifying that the selection is not effective is displayed to require confirmation by the user. When a “RETURN” button 306 is clicked, the “CONTENTS RESERVATION” screen is closed to return to the “DOWNLOAD RESERVATION SERVICE” screen shown in FIG. 2.

FIG. 4 is a view showing one example of a “CONFIRMATION OF CONTENTS RESERVATION” screen, where the reserved states are displayed, and, at the same time, a time (reproduction time) required for reproduction of the reserved contents: a time for download of the contents: and a data size (contents size) of the contents are also displayed after acquisition of them through the Internet. The reproduction time, download time, contents size and so on are automatically changed when the contents or media type are altered.

When the user clicks a “RESERVATION” button 401, a “CONTENTS RESERVATION ACCEPTANCE” screen is displayed to terminate a series of a reservation procedures. The current reservation contents and, at the same time, a “INQUIRY ID” as an identifier allocated to the current reservation contents are displayed on the “CONTENTS RESERVATION ACCEPTANCE” screen.

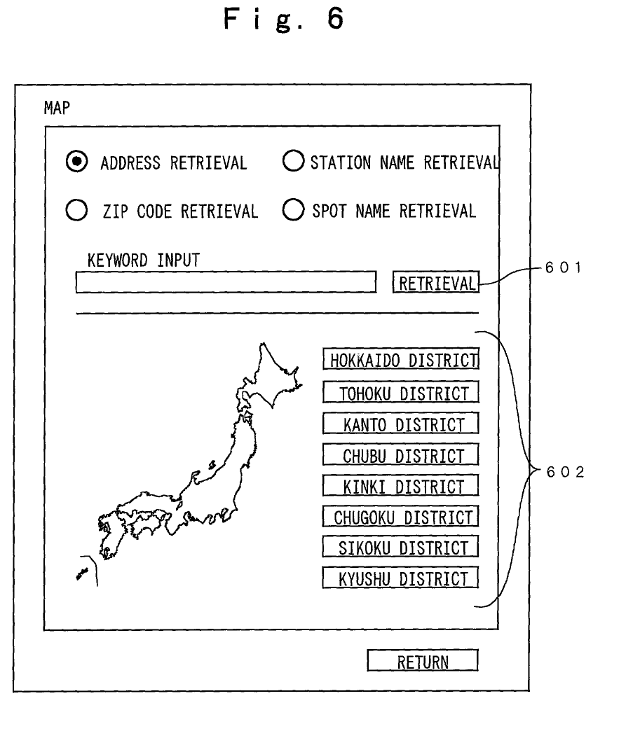

FIG. 6 is a view showing one example of a “MAP” screen displayed when the “MAP” button 302 is clicked on the “CONTENTS RESERVATION” screen shown in FIG. 3, and “ADDRESS RETRIEVAL”, “STATION NAME RETRIEVAL”, “ZIP CODE RETRIEVAL”, and “SPOT NAME RETRIEVAL” are provided for classification of keyword retrievals in the present embodiment. After selection of a radio button for a desired retrieval item, the user inputs a desired keyword into a keyword input window, and clicked a “RETRIEVAL” button 601. Thereby, a peripheral map for a place responding to the key word at the retrieval is displayed.

In the present embodiment, the peripheral map may be displayed even by specification of a position on a map, other than by the key word retrieval, and a plurality of district buttons 602 such as a “HOKKAIDO DISTRICT” button and a “TOHOKU DISTRICT” button are provided. When one of any district buttons 602 is clicked, a map for a pertinent district is displayed.

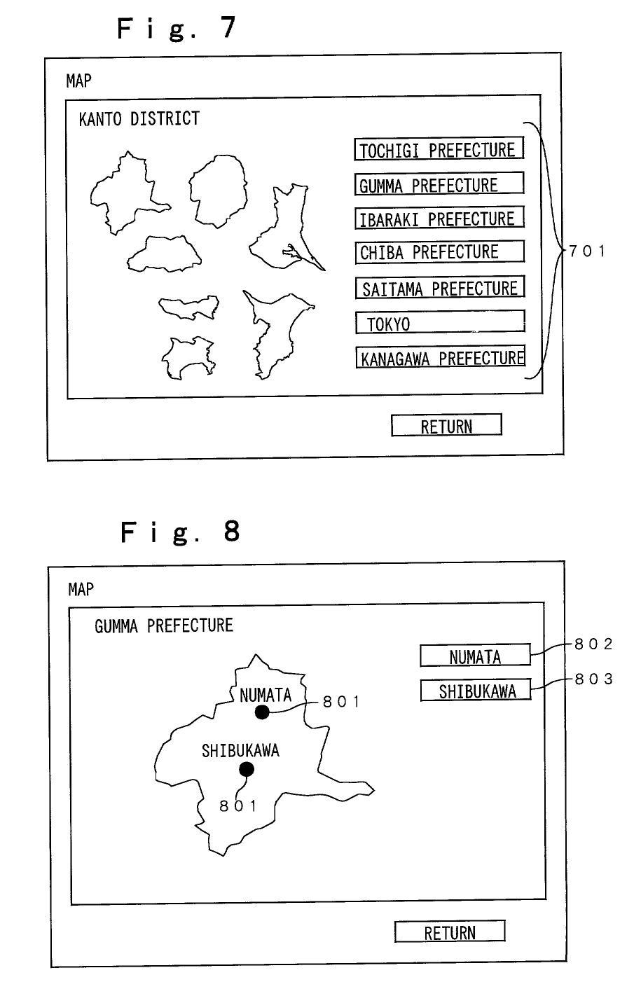

FIG. 7 is a view showing one example of a map displayed when the “KANTO DISTRICT” button 602 is clicked, and prefecture name buttons 701 and topographical maps responding to each prefecture in the Kanto district. When the “GUMMA PREFECTURE” button 701 is clicked, a brief map for Gumma Prefecture and, at the same time, marks 801 denoting positions (Numata-shi, and Shibukawa-shi in the present embodiment) where contents may be provided in the pertinent prefecture are displayed, as shown in FIG. 8. Furthermore, a “NUMATA” button 802 and a “SHIBUKAWA” button 803 for specification of the pertinent position as a “RESERVATION PLACE” are displayed. When the user clicks the “NUMATA” button 802, Numata-shi is reserved for a contents download place, that is, a “RESERVATION PLACE”.

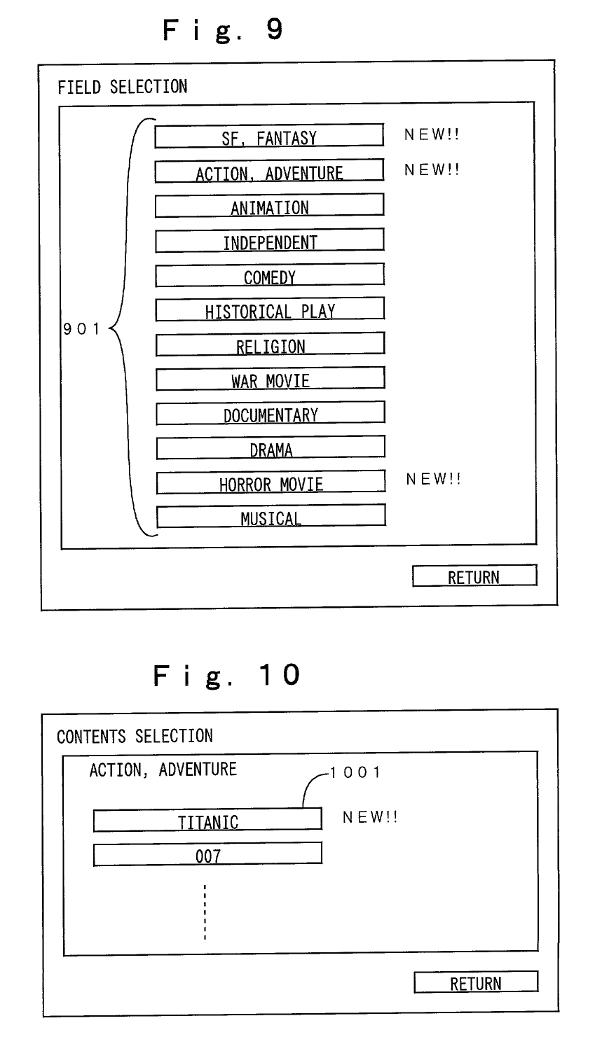

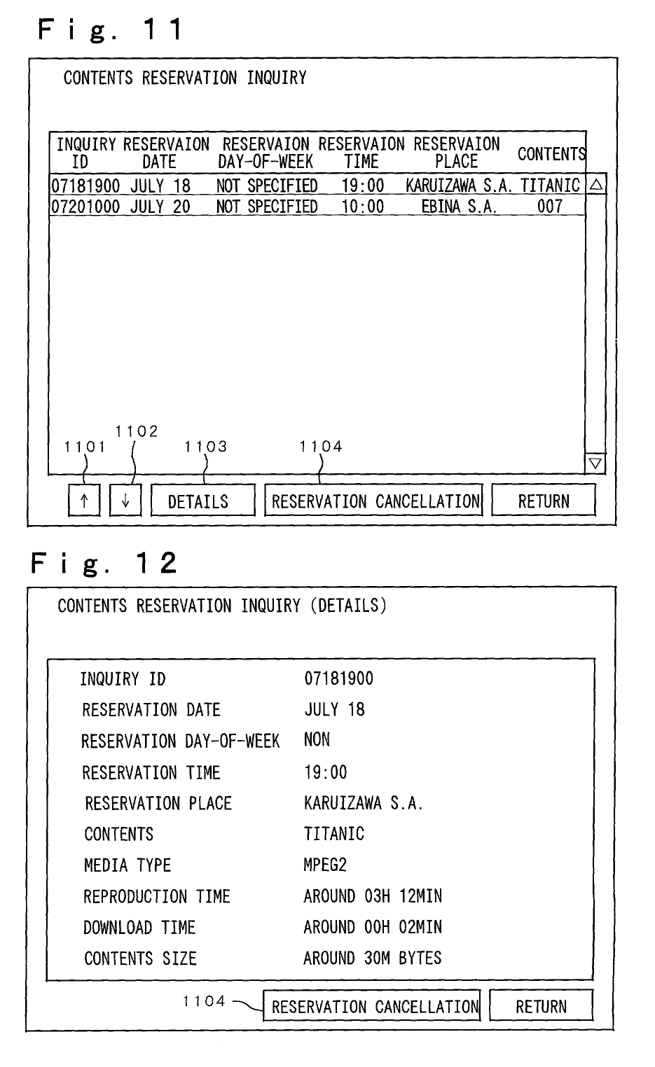

FIG. 9 is a view showing one example of a “FIELD SELECTION” screen displayed when the “FIELD SELECTION” button 303 is clicked in the “CONTENTS RESERVATION” screen shown in the FIG. 3, and a plurality of “FIELD SELECTION” buttons 901 responding to a number of the fields of contents are displayed. Here, “NEW!!” displayed in the right side of the “FIELD SELECTION” buttons 901 denotes, for example, that there are included contents which may be newly provided within the coming one week and have not yet been downloaded to the pertinent user.

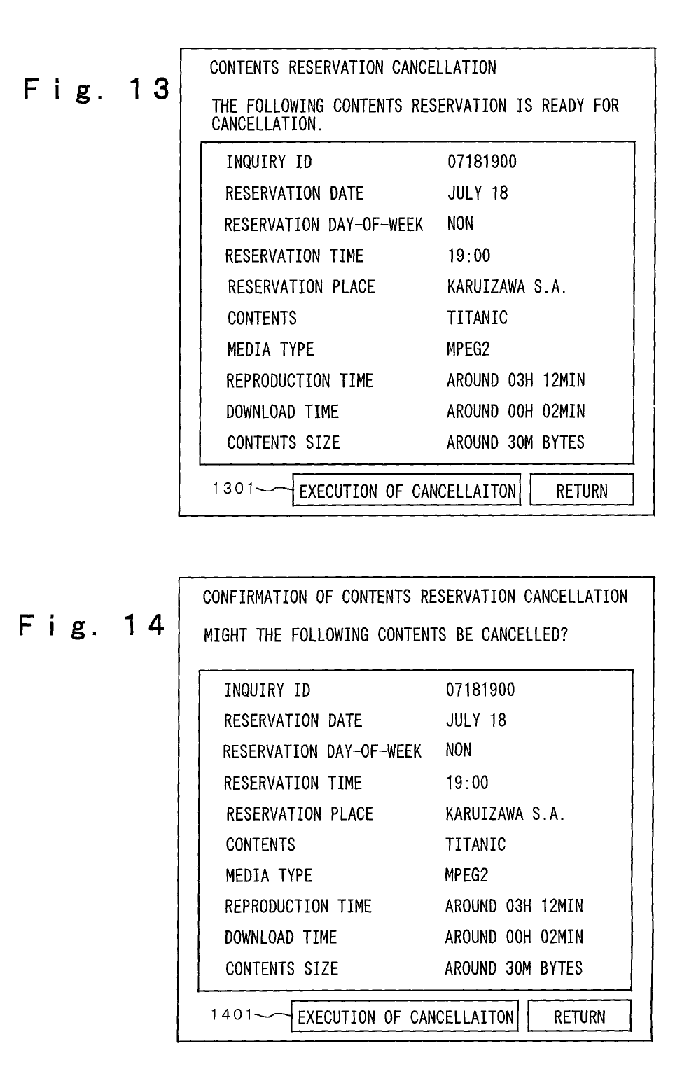

When an “ACTION, and ADVENTURE” button is clicked, the “CONTENTS SELECTION” screen shown in FIG. 10 is displayed, and there are displayed a plurality of buttons having each contents name the contents piece of which belongs to the pertinent field and may be provided. When a “TITANIC” button 1001 is clicked, a movie “TITANIC” is reserved as contents, and “TITANIC” is displayed in a contents selection window on the “CONTENTS RESERVATION” screen shown in the FIG. 3.

FIG. 11 is a view showing one example of a “CONTENTS RESERVATION INQUIRY” screen displayed when the “CONTENTS RESERVATION INQUIRY” button 202 is clicked in the “DOWNLOAD RESERVATION SERVICE” screen shown in the FIG. 2. A list showing contents of all the reservations is displayed with the corresponding IDs.

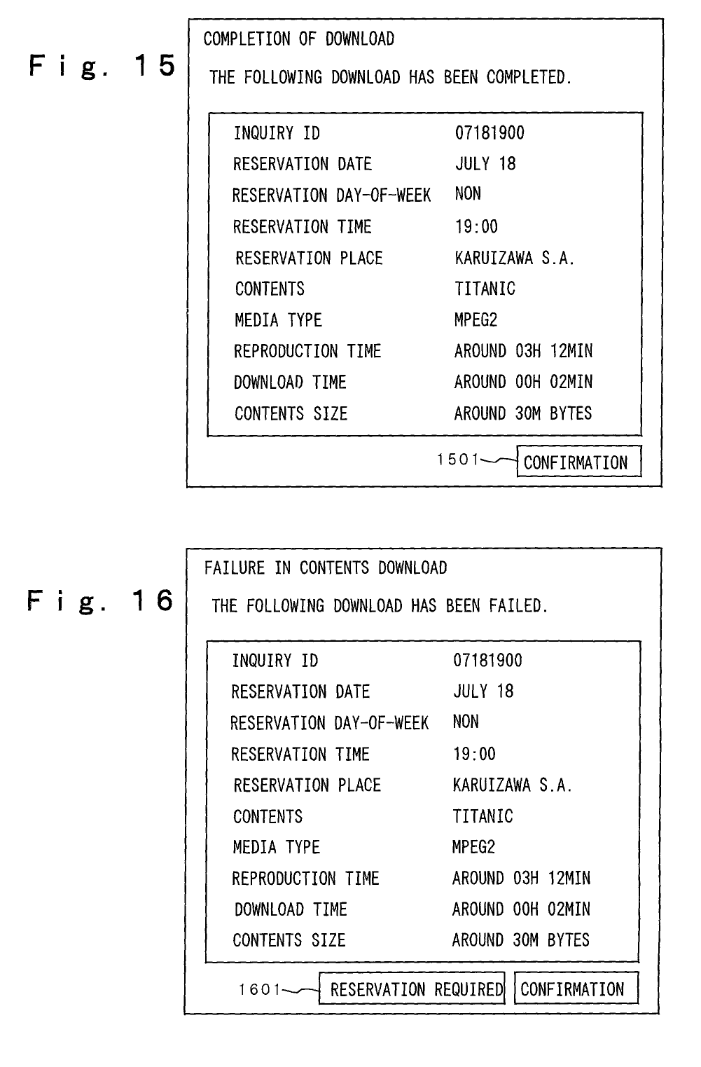

A desired reservation in a list is selected by clicking an arrow button for ascending 1101 or a descending one 1102, or, by highlighting any one of the reservations in the list, and, moreover, a “CONTENTS RESERVATION INQUIRY (DETAILS)” screen shown in FIG. 12 is displayed, when a “DETAILS” button 1103 is clicked. When a “RESERVATION CANCELLATION” button 1104 is clicked after selection of one reservation, a “CONTENTS RESERVATION CANCELLATION” screen shown in FIG. 13 is displayed.

When the user confirms the displayed contents on the display and clicks a “CANCELLATION EXECUTION” button 1301, a “CONFIRMATION OF CONTENTS RESERVATION CANCELLATION” screen shown in FIG. 14 is displayed.

When the user clicks a “CANCELLATION EXECUTION” button 1301 or 1401, the pertinent reservation is cancelled.

FIGS. 20 to 24 is a sequence diagram showing a flow according to which the user reserves desired contents: the reserved contents are cached from contents servers (a group of them) 12 (FIG. 1) to a predetermined cache server 6: and, moreover, the contents are provided to the user at a predetermined timing. The present embodiment describes as an example a case where the user reserves acquisition of contents with the reservation user terminal 8, and the contents are downloaded to the mobile terminal 10.

In FIG. 20, the reservation data are registered with the schedule server 5 from the reservation user terminal 8 through the Internet 1 at STEP 1, when the user reserves desired contents on the “CONTENTS RESERVATION” screen (FIG. 3) displayed on the display of the reservation user terminal 8, and clicks the “RESERVATION” button 305.

FIG. 18 shows the reservation data registered in schedule server 5. Contents ID, reservation dates, reservation day-of-weeks, reservation times, reservation places, media types, reproduction times, download times, and contents sizes are registered for every inquiry IDs peculiar to each reservation.

At STEP 2, the schedule server 5 confirms the reservation data, and the confirmation results are returned to the reservation user terminal 8 as a “CONFIRMATION OF CONTENTS RESERVATION” screen (FIG. 4). The reservation data are formally registered with the schedule server 5, when the user confirms the reservation data on the screen, and clicks the “RESERVATION” button 401. The schedule server 5 allocates a peculiar inquiry ID to the reservation data, and returns the “CONTENTS RESERVATION ACCEPTANCE” screen (FIG. 5) to the reservation user terminal 8.

At STEP 3, the schedule server 5 registers with the time control server 4 notification of time out to itself at a reservation time. It is preferable to perform the notification a contents download time before the reservation time, considering the contents download time from the cache server 6 to the mobile terminal 10.

At STEP 4, a request for selecting a cache server finally to download the contents to the user mobile terminal 10 is sent from the schedule server 5 to the position control server 3. At STEP 5, the position control server 3 responds to the selection request for comparison between the reservation place and positions of each cache server, and determines a cache server for download of the contents to the mobile terminal 10. The determination result is notified from the position control server 3 to the schedule server 5. In the present embodiment, the following description will be made, assuming that the cache server 6b is selected.

When there is no cache server for download of the contents to the mobile terminal 10 at the reservation place, the schedule server 5 receives the notification of no cache server at the place and a proposal for alternative places which may be provided. The schedule server 5 suggests the proposal to the reservation user terminal 8 at STEP 6, and is waiting for another reservation request from the reservation user terminal 8.

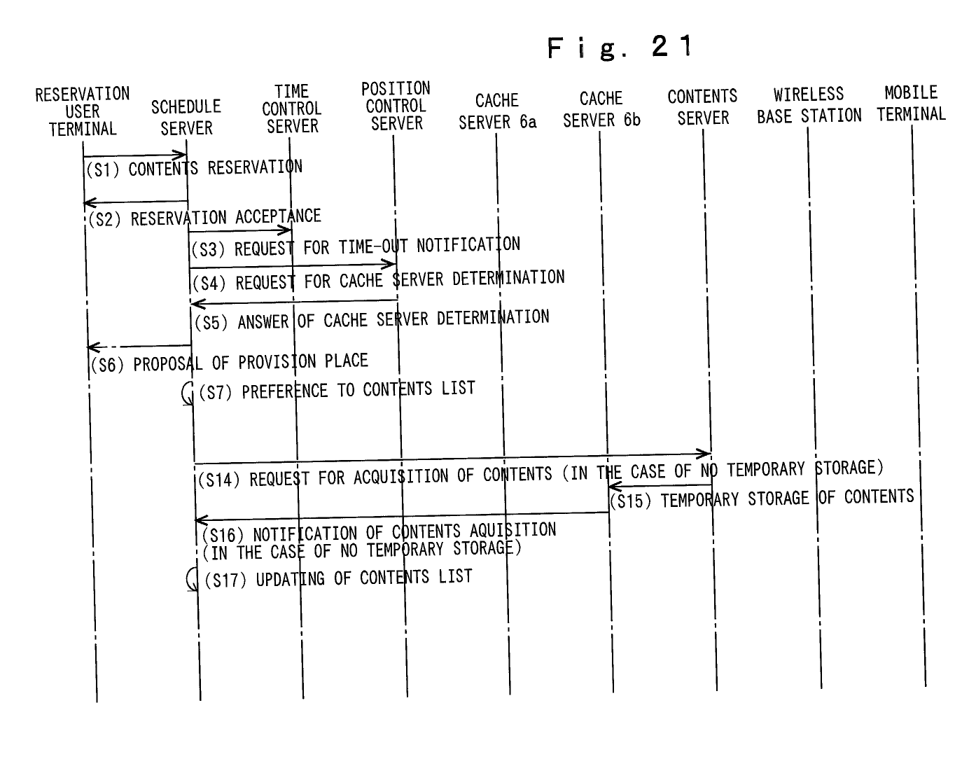

At STEP 7, the schedule server 5 determines whether the reserved contents have already been stored in any one of cache servers for reuse of the contents, referring to its own contents list 5a. When the reserved contents are not temporarily stored even in any one of cache servers, the process advances to STEP 14 in FIG. 21 which will be described later.

FIG. 19 is a view of a typical expression of one example of the contents list 5a. For every contents, IDs of the cache servers in which the pertinent contents have been temporarily stored is registered respectively.

If the reserved contents have been temporarily stored in a plurality of cache servers, the process advances to STEP 8 (FIG. 20). At STEP 8, the schedule server 5 inquires in advance to the position control server 3 about a preferable cache server which is geographically located at the closest position, or has the shortest time for contents movement. At STEP 9, the inquiry results (the cache server 6a in the present embodiment) are received, and the process advances to STEP 10. If the reserved contents has been temporarily stored only in any one of the cache servers (the cache server 6a in the present embodiment), the process immediately advances to STEP 10.

At STEP 10, the schedule server 5 makes a request to the cache server 6a for movement or reproduction (hereinafter, represented by the movement) of the contents. At STEP 11, the cash server 6a moves the contents temporarily stored in itself to the selected cache server 6b, responding to the movement request. In the case of completion of the movement, the notification of the completion is sent from the cache server 6b of the movement end to the schedule server 5 at STEP 12. At STEP 13, the schedule server 5 updates the own contents list 5a, responding to the completion notification.

When it is found that there is no temporary storage of the reserved contents in any of cache servers after referring to the contents list 5a in step 7 (FIG. 20), the schedule server 5 has an access to contents servers (a group of them) 12 through the Internet 1 and soon to make a request for contents acquisition at STEP 14, as shown in FIG. 21. At STEP 15, the contents are temporarily stored from the contents servers (a group of them) to the cache server 6b. When the schedule server 5 receives the completion notification of contents acquisition from the cache server 6b at STEP 16, contents which are temporarily and newly stored, and cache server 6b are added to the contents list 5a (FIG. 19) for updating at STEP 17.

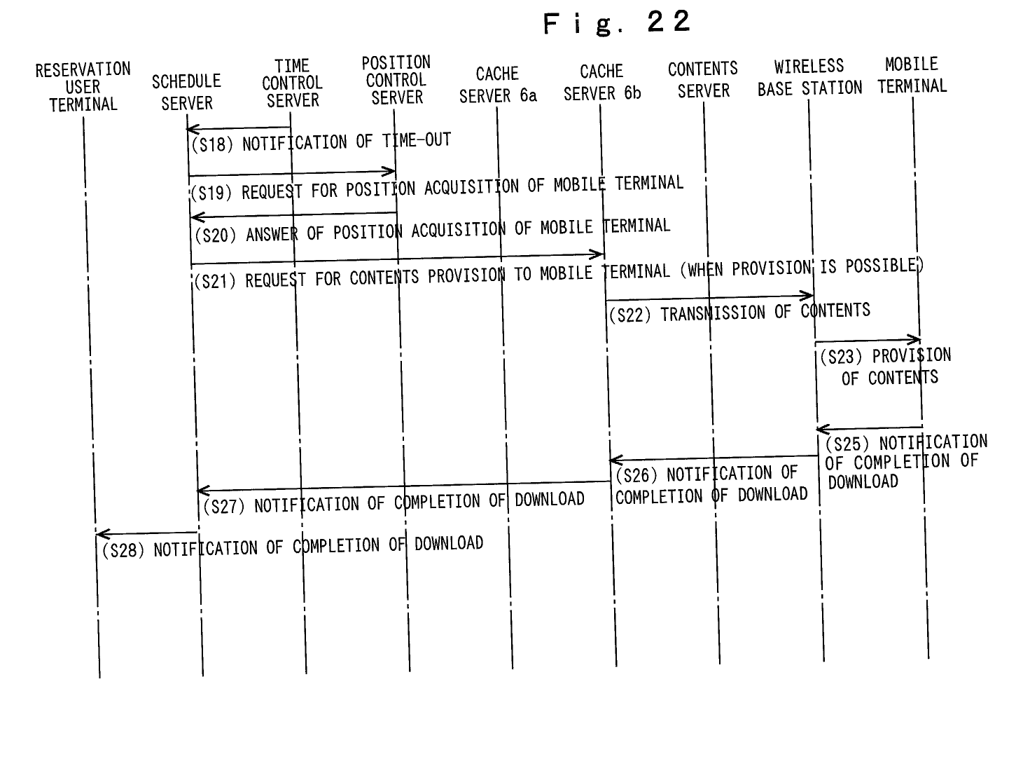

Thereafter, the schedule server 5 receives the time out notification from the time control server 4 at STEP 18 in FIG. 22: then, inquiry about the current position of the mobile terminal 10 is made to the position control server 3 at STEP 19: and the current position of the mobile terminal 10 is received from the position control server 3 at STEP 20. When the schedule server 5 compares the current position and the reservation position of the mobile terminal 10, and determines that the both is near in their positions each other and the contents download from the cache server 6b to the mobile terminal 10 is possible as scheduled, the cache server 6b is instructed to perform the contents download at STEP 21.

At STEP 22, the cash server 6b sends the contents, which have been cached beforehand, to a wireless base station corresponds to the instruction for the download. At STEP 23, the contents are downloaded from the wireless base station to the mobile terminal 10. After completion of normal reception of the contents, the mobile terminal 10 notifies the completion to the reservation user terminal 8 (STEP 28) through the wireless base station (STEP 25), the cache server 6b (STEP 26), the schedule server 5 (STEP 27), and so on.

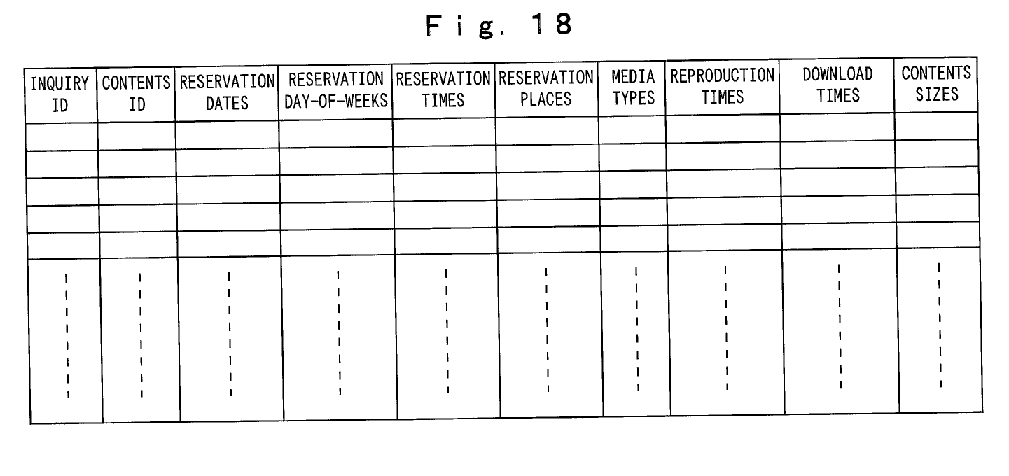

With the reservation user terminal 8, a “Completion of download” screen shown in FIG. 15 appears on the display, and a message that the download of the contents has been normally completed is displayed with the inquiry ID and the reservation data. When a “CONFIRMATION” button 1501 is clicked on the “COMPLETION OF DOWNLOAD” screen, a series of processes terminates.

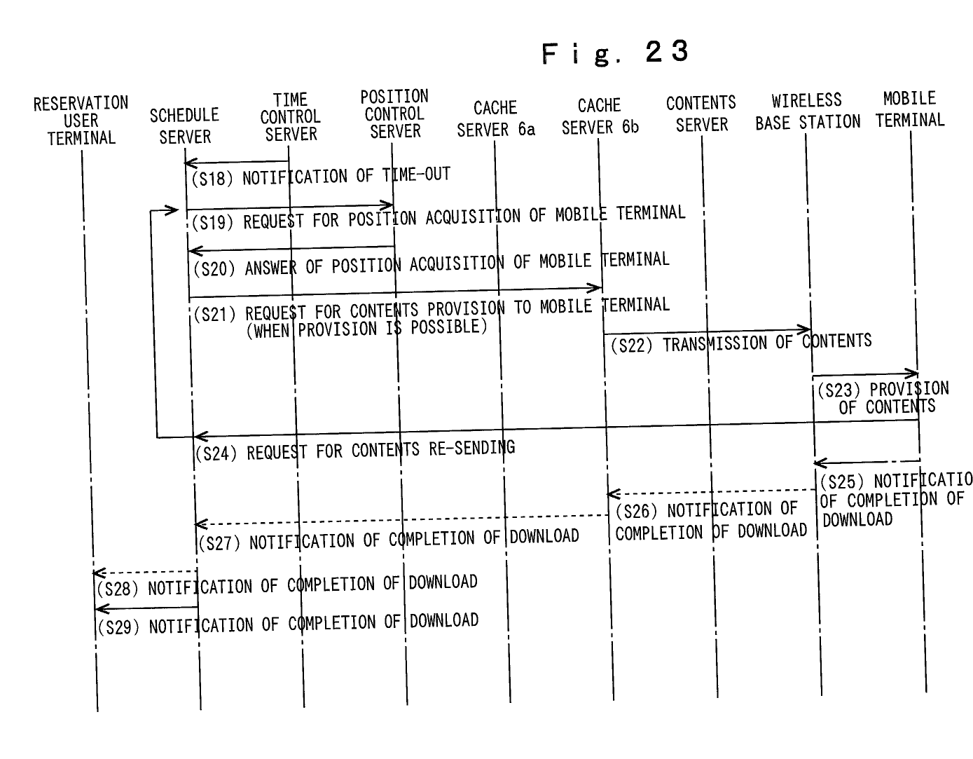

When the download of the contents cannot be normally performed owing to deterioration in the communication path quality and the moving state of the mobile terminal 10, the mobile terminal 10 makes a request to the schedule server 5 for re-sending of the contents at STEP 24, as shown in FIG. 23. The schedule server 5 which receives the re-sending request repeats the processes after the STEP 19. When there is successful download by there-sending,the mobile terminal 10 notifies the completion of the contents provision to the reservation user terminal 8 (STEP 28) through the wireless base station (STEP 25), the cache server 6b (STEP 26), and the schedule server 5 (STEP 27) in a similar manner to the description, after completion of normal reception of the contents. Thereby, the contents provision normally terminates.

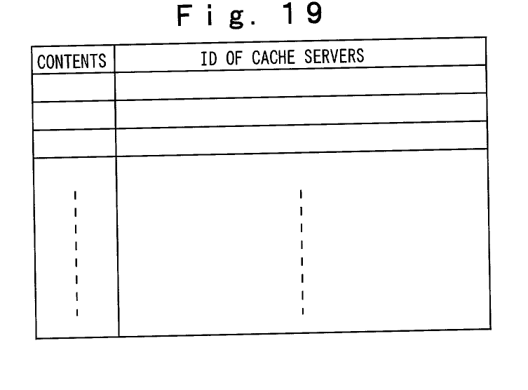

When the number of the re-sending requests is over a predetermined number, the schedule server 5 stops the subsequent re-sending, and notifies the failure in the contents provision to the reservation user terminal 8 at STEP 29. With the reservation user terminal 8, a “FAILURE IN CONTENTS DOWNLOAD” screen shown in FIG. 16 appears on the display, and a message that there has been failed download of the contents is displayed with the inquiry ID and the reservation data. When a “RESERVATION REQUESTED” button 1601 is clicked on the “FAILURE IN CONTENTS DOWNLOAD”, the contents reservation screen shown in the FIG. 2 is displayed for re-reservation of contents.

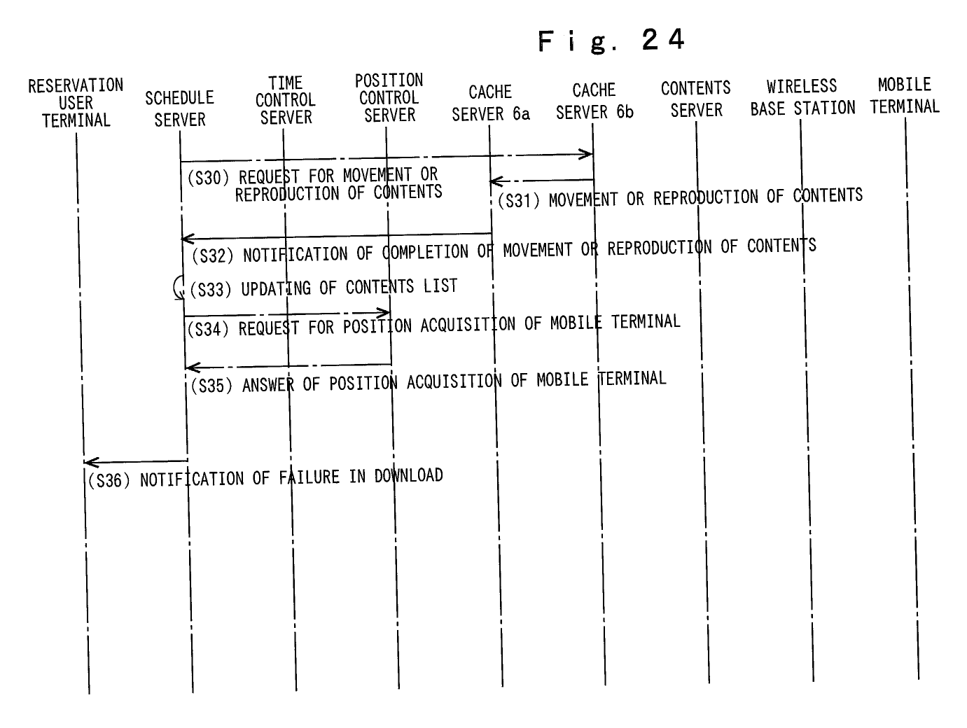

When there is no download of the contents from the cache server 6b to the mobile terminal due to large distance between the current position of the mobile terminal 10 confirmed at the STEPs 19, 20 and the reservation position, the schedule server 5 makes a request to the cache server 6b for movement of the contents to a cache server at the best position at STEP 30 in FIG. 24. The cache server 6b transfers the contents cached by itself to the cache server at the best position (the cache server 6a in the present embodiment) at STEP 31.

After completion of caching of the contents, the cache server 6a notifies the completion of the movement to the schedule server 5 at STEP 32. The schedule server 5 updates its own contents list 5a at STEP 33, responding to the notification of the movement completion.

When the schedule server 5 cannot download the contents from the cache server 6a currently provided at the best position to the mobile terminal 10 owing to the movement state of the mobile terminal the server 5 makes re-inquiry to the position control server 3 about the current position of the mobile terminal 10 at STEP 34: and receives the current position of the mobile terminal 10 from the position control server 3 at STEP 35.

Thereafter, the processing from the STEP 30 to the STEP 35 are repeated until success in download. In the case of no download even after the processes are repeated a fixed number of times, the schedule server 5 notifies the failure in the contents provision to the reservation user terminal 8 at STEP 36 in a similar manner to the description.

According to the present embodiment, the reserved contents are previously cached to a cache server at a position suitable for provision of the contents at the reservation time in the reservation place, when the user makes a reservation on contents, dates, and places which the user wants to acquire. Therefore, the user receives the desired contents with high quality even with the mobile terminal 10 in a short time.

According to the present embodiment, a cache server which can perform download to the mobile terminal 10 at the current position is re-selected, and the reserved contents is re-cached to the pertinent cache server, when the user cannot reach the reservation place until the reservation time. Therefore, the download of the contents may be realized even when the user cannot reach the reservation place.

In the embodiment, the description has been made, assuming that the reserved contents are temporarily stored in one cache server, and the download to the user mobile terminal is performed only from the one cache server. However, the reserved contents may be divided for temporary storage into a plurality of cache servers, and the divided contents may be provided to the mobile terminal from the plurality of cache servers in order to perform highly reliable contents provision under controlling effects by communication interruption and deterioration in communication quality to the minimum.

According to such divisional download, reduced time for the provision and at the same time high-reliable contents provision may be realized even in the case of no normal download of the contents, as there is no requirement for another re-sending of the whole contents, and only small pieces of the contents needs re-sending.

For example, the contents are divided for temporary storage not only in a cache server near the reservation, but also in one or a plurality of cache servers on this side, when a group of wireless base stations, and cache servers (a group of them) are arranged along an expressway. In such a way, the download may be completed when the user reaches the reservation place, as the download advances by steps along the route toward the reservation place, even if the user reaches the reservation place behind the reservation time by heavy traffic. The number of cache servers for downloaded arrangement of contents pieces depends on the capacity of the contents, and the larger capacity of the contents preferably needs more number of cache servers.

Moreover, the following modifications may be executed without departing from the true spirit and scope of the present invention in the present invention.

(1) The First Example of Modifications

The user may be encouraged to change the reservation data after comparison between the reservation date and reservation place required by the user and the current position of the mobile terminal and traffic information which may be obtained with the Internet.

The schedule server 5 estimates the moving speed V of the mobile terminal 10 (80 Km/h in the present embodiment) by a plurality of inquiries to the position control server 3 about the position of the mobile terminal 10, assuming, for example, that acquisition of a movie “TITANIC” is reserved at 19:00 on July 18 and at Karuizawa S. A. (Service Area). And, a distance X (40 Km in the present embodiment) between the position at which the mobile terminal 10 made the last inquiry to the position control server 3, and the one of the Karuizawa S. A. is estimated.

A time (=30 minutes) for reaching Karuizawa S. A. is calculated using the moving speed V (=80 Km/h) and the distance X (=40 Km). If the arriving time at Karuizawa S. A. is before 18:30, the schedule server 5 determines that the mobile terminal 10 can arrive at the reservation place before the reservation time, and prepares for the contents provision based on the initial reservation. If the estimated arriving time is after 18:30, the schedule server 5 determines that the mobile terminal 10 cannot arrive at the reservation place before the reservation time, and suggests to the user the contents provision (download) at this side of Karuizawa S. A.

(2) The Second Example of Modifications

When the contents provision becomes possible even before the reservation time, the possibility is notified to the reservation user terminal or the mobile terminal and earlier provision is proposed.

(3) The Third Example of Modifications

Assuming that the mobile terminal cannot reach the reservation place before the reservation time, the same contents are temporarily stored not only in the most suitable cache server for the reservation place, but also in one or a plurality of cache servers on this side of the most suitable server. Thereby, the reserved contents can be downloaded to the user at a cache server on this side, even when the mobile terminal cannot arrive at the reservation place before the reservation time.

(4) The Fourth Example of Modifications

The temporary storage interval of the contents in each cache server is assumed to be variable, depending on the capacity of each cache server. For example, the holding duration is assumed to be 24 hours in the case of a cache server with a capacity of 100 G bytes, and 12 hours in the case of one with a capacity of 50 G bytes.

(5) The Fifth Example of Modifications

The user is configured to determine only contents at reservation, and neither of a reservation time and a reservation place. In regard to the reservation time and the reservation place, the system lets the user to select a suitable time and place or appropriate times and places among presented candidates for them which can provide the reserved contents.

(6) The Sixth Example of Modifications

The reservation date with a range is configured to be given, for example, a time zone is configured to be specified for the reservation time. In such a time, the cache server is prohibited from contents deletion during the time zone. The contents download is started by the instruction from the mobile terminal.

(7) The Seventh Example of Modification

Not only the reservation place and the reservation time, but also the processing capacity and the processing performance of the mobile terminal are configured to be specified at reservation. In the case of the low processing capability of the mobile terminal, the information quantity for the download is configured to be reduced by increasing the coding rate, by higher compression rate and so on when the contents are downloaded from the cache servers to the mobile terminal.

For example, the contents according to the MPEG2 coding standard are converted into the ones according to the MPEG4 standard with comparatively reduced information quantity. Or, the contents are transmitted, giving priority to the I frames indispensable for the decoding among the I, P, and B frames in the MPEG2 coding standard.

The user does not specify the capability of the mobile terminal at the reservation, but the cache server for contents download to the mobile terminal judges the capacity of the mobile terminal, and may reduce the information quantity for the download by increasing the coding rate, by higher compression rate, and so on in the case of the low capability of the mobile terminal.

In such a case, the contents are provided according to the processing capacity and the processing performance of the mobile terminal by provision of, for example, a media conversion program from the MPEG2 standard to the MPEG4 one, or a frame filter to the schedule server 5, each cache server, or a part of cache servers.

According to the present embodiments, the following advantages are obtained:

(1) When the user reserves contents which the user wants to acquire, and the corresponding date and place, the reserved contents are temporarily stored beforehand into a cache server at a position suitable for provision of the contents at the reserved time and the reserved place. Therefore, the user may receive the desired contents downloaded with high quality even from a mobile terminal in a short time.

(2) When the user cannot reach the reservation place before the reservation time, a cache server which can download the contents to the mobile terminal at the current position is re-selected, and the reserved contents is temporarily re-stored into the pertinent cache server. Therefore, the download of the contents may be realized even when the user cannot reach the reservation place before the reservation time.

What is claimed is:

1. A method for contents provision where reserved contents are downloaded to a mobile terminal at a predetermined timing, comprising:
a step for display of a reservation screen on which the content ID, and geographical and time conditions for download of the contents are reserved;
a step for selection of a temporary storage means meeting the reserved geographical conditions among a plurality of temporary storage means which are geographically arranged in a downloaded manner;
a step for storage of contents, which are corresponding to the ID input on the reservation screen, into the selected temporary storage means after acquisition of the contents on the network; and
a step for download of the contents stored in the temporary storage means to the mobile terminal at a timing satisfying the time conditions input on the reservation screen.

2. A method for contents provision according to claim 1, wherein the reservation screen comprises:
a contents reservation column for specification of contents which is desired to be downloaded;
at least one of a reservation date column and a reservation day-of-week column for specification of a desired acquisition date of the contents; and
a reservation time column for specification of a desired acquisition time of the contents.

3. A method for contents provision according to claim 1, wherein the reservation screen comprises a map screen for display of a plurality of positions at which download of contents may be realized, and a position selected on the map screen is reserved as the geographical conditions for download of the contents.

4. A method for contents provision according to claim 1, wherein the reservation screen comprises: a first window for list of contents fields; and a second window for list of contents names belonging to the selected fields on the first window, and acquisition reservation of the contents specified in the second window.

5. A method for contents provision according to claim 1, wherein a plurality of temporary storage means are selected to store the contents into each temporary storage means, and for download of the contents stored in any one of temporary storage means to a mobile terminal.

6. A method for contents provision according to claim 1, wherein a plurality of temporary storage means are selected to store the contents divisionally into each temporary storage means, and for download of each of the divided contents pieces stored respectively in temporary storage means to a mobile terminal.

7. A method for contents provision according to claim 6, wherein the number of temporary storage means stored the contents are selected corresponding to the capacity of the contents.

8. A method for contents provision according to claim 1, comprising:
a step for detection of a position of the mobile terminal before download of the contents to the mobile terminal;
a step for re-selection of a temporary storage means corresponding to the current position of the mobile terminal when the mobile terminal has not reached the reservation position meeting the geographical conditions; and
a step for movement or reproduction of the contents, which are temporarily stored in temporary storage means selected based on the input geographical conditions, to the re-selected temporary storage means based on the current position of the mobile terminal, and
downloading of contents which have been temporarily stored in the re-selected temporary storage means to the mobile terminal.

9. A method for contents provision according to claim 1, comprising:
a step for detection of the current position and the moving speed of the mobile terminal;
a step for estimation of the arriving position of the mobile terminal at the reservation time as the time conditions, based on the detection results.
a step for judgment based on the current position, the moving speed, and the estimated arrival position of the mobile terminal whether or not the mobile terminal can arrive the reservation position as the geographical conditions before the reservation time.
a step for selection of a temporary storage means according to the estimated arrival position of the mobile terminal when it is judged that the terminal can not arrive the reservation place before the reservation time;
a step for temporary storage of the contents in the selected temporary storage means; and
a step for download of the contents stored in the temporary storage means to a mobile terminal at a timing as the time condition input on the reservation screen.

10. A method for contents provision according to claim 1, comprising:
a step for judgment whether or not the reserved contents has been stored in a second temporary storage means other than the selected temporary storage means; and
a step for movement or reproduction of the contents from the second temporary storage means to the selected temporary storage means when the reserved contents has been stored in the second temporary storage means.
